(19) United States
(12) Patent Application Publication
(10) Pub. No.: US 2010/0117989 A1
(43) Pub. Date: May 13, 2010

(54) TOUCH PANEL MODULE AND TOUCH PANEL SYSTEM WITH SAME

(75) Inventor: JEN-TSORNG CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/494,276

(22) Filed: Jun. 30, 2009

(30) Foreign Application Priority Data
Nov. 12, 2008 (CN) 200810305505.3

(51) Int. Cl. G06F 3/042; G06F 3/041

(52) U.S. Cl. 345/175; 345/173

(57) ABSTRACT

An exemplary touch panel module includes a touch panel, a supporting body, a plurality of first elastic members sandwiched between the touch panel and the supporting body, and a plurality of displacement sensors mounted on the supporting surface. The touch panel includes a touch surface, and a reflection surface opposite to the touch surface. The supporting body includes a supporting surface facing the reflection surface. Each first elastic member is deformable along a direction substantially perpendicular to the touch surface. Each displacement sensor is configured for sensing deformation of the corresponding first elastic member.

### BACKGROUND

1. Technical Field

The present disclosure generally relates to control systems, and particularly to touch panel modules, and touch panel systems with the touch panel module.

2. Description of Related Art

With the rapid development of science and technology, portable electronic devices, such as notebook computers, personal digital assistants (PDAs), mobile phones, global positioning systems (GPSs) and multimedia players, are now widely used in many people's lives. A typical portable electronic device is equipped with a number of mechanical input keys, and a display for displaying information (e.g., characters, pictures, etc.) thereon. The keys are used to input information/commands to the portable electronic device. However, with the ongoing trend of portable electronic devices becoming more and more multifunctional and miniaturized, the keys are commonly considered to take up a significant and unduly large amount of space.

Therefore, what is needed is a touch panel module which can overcome the limitations described, and a touch panel system with the touch panel module.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of a touch panel system according a first embodiment, the touch panel system including a touch panel module and a central processing unit (CPU) electrically coupled to the touch panel module.

FIG. 2 is an exploded view of the touch panel system shown in FIG. 1.

FIG. 3 is a cross sectional view of the touch panel module taken along the line IIII-III of FIG. 1, the touch panel module including a plurality of displacement sensors.

FIG. 4 is a schematic view of the displacement sensor working principle of FIG. 2.

FIG. 5 is a cross sectional view of the touch panel module of FIG. 3 when touched at a point P.

FIG. 6 is a cross sectional view of a touch panel module according to a second embodiment.

FIG. 7 is a cross sectional view of a touch panel module according to a third embodiment.

### DETAILED DESCRIPTION

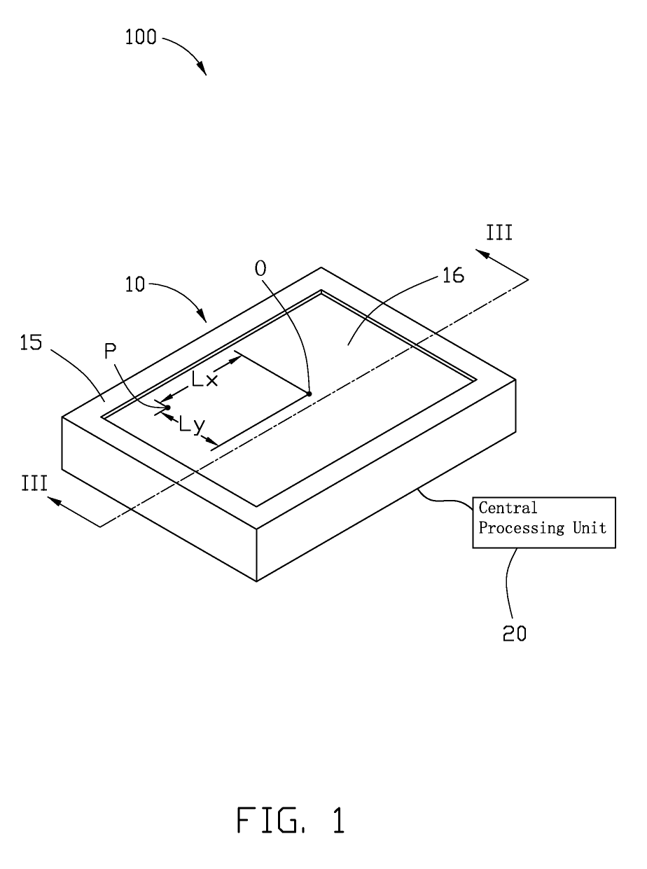

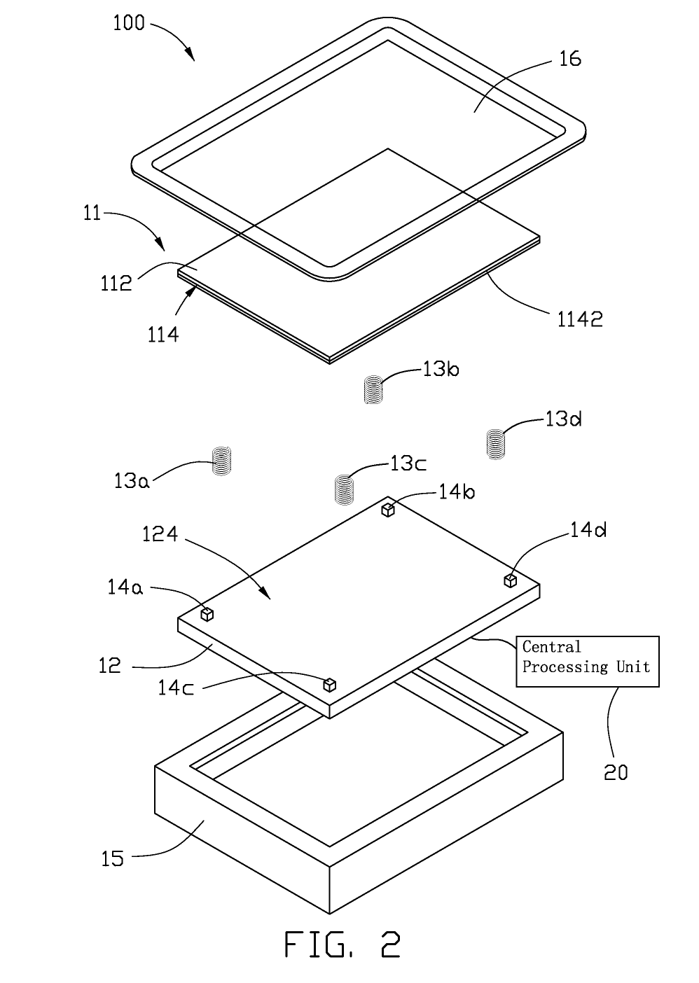

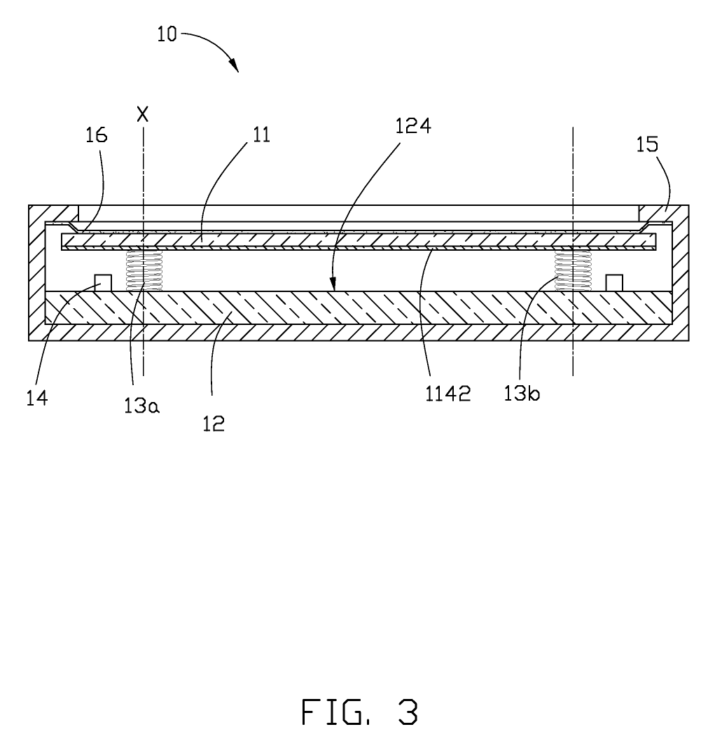

Referring to FIGS. 1-3, a touch panel system 100, in accordance with a first embodiment, includes a touch panel module 10, and a central processing unit (CPU) 20 electrically coupled to the touch panel module 10.

The touch panel module 10 includes a touch panel 11, a supporting body 12 facing and under the touch panel 11. There are four first elastic members 13a, 13b, 13c, 13d sandwiched between the touch panel 11 and the supporting body 12. There are four displacement sensors 14a, 14b, 14c, 14d mounted on the surface and facing the touch panel 11 of the supporting body 12. There is a receiving frame body 15 for receiving the touch panel 11 and the supporting body 12 therein. There is also a protecting film 16 mounted on the upper surface of the touch panel 11 for protecting the touch panel 11 from contamination.

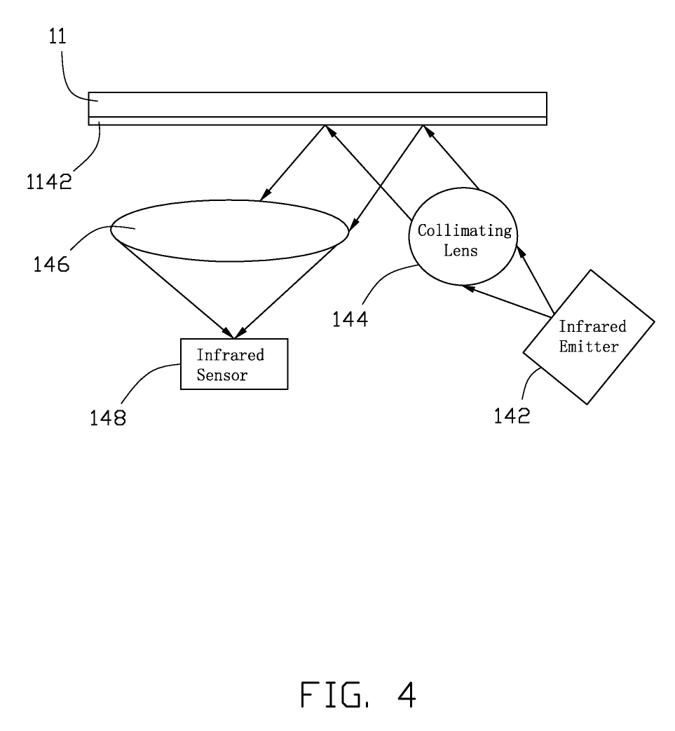

The touch panel 11 is light pervious. The touch panel 11 includes a touch surface 112, and a reflection surface 114 opposite to the touch surface 112. The touch surface 112 is configured for being touched by a user. An infrared reflection film 1142 is mounted on the reflection surface 114. The infrared reflection film 1142 reflects infrared rays to prevent infrared rays passing through the touch panel 11 from an infrared emitter 142 (see FIG. 4). In this embodiment, the touch panel 11 is square shaped.

The supporting body 12 includes a supporting surface 124 facing the reflection surface 1142. In this embodiment, the supporting body 12 is a square shaped fluid crystal display plate. In other embodiment, the supporting body 12 can instead be a light pervious plate.

The four first elastic members 13a, 13b, 13c, 13d are respectively disposed in four corners of the supporting body 12. Each of the four first elastic members 13a, 13b, 13c, 13d is deformable along a direction X substantially perpendicular to the touch surface 112. One end of each of the first elastic members 13a, 13b, 13c, 13d is connected to the touch panel 11. Other end of each of the first elastic members 13a, 13b, 13c, 13d is connected to the supporting body 12 to connect the touch panel 11 to the supporting body 12. In this embodiment, the first elastic members 13a, 13b, 13c, 13d are springs with the same elasticity coefficient.

The four displacement sensors 14a, 14b, 14c, 14d are respectively mounted in four corners of the supporting surface 124, and near the respective first elastic members 13a, 13b, 13c, 13d for sensing deformations of the respective first elastic members 13a, 13b, 13c, 13d.

The middle potion of the protecting film 16 is adhered to the touch surface 12 of the touch panel 11. The periphery of the protecting film 16 is adhered to an inner wall of the frame body 15 to connect the frame body 15 to the touch panel 11 forming a seal to protect the touch panel 11 from contamination.

Referring also to FIG. 4, each of the displacement sensors 14a, 14b, 14c, 14d includes the infrared emitter 142, a collimating lens 144, a focusing lens 146, and an infrared sensor 148. The collimating lens 114 receives infrared rays from the emitter 142, and collimates the infrared rays into collimated rays. The collimated rays are reflected to the focusing lens 146 by the infrared reflection film 1142 mounted on the reflection surface 114, then, converged by the focusing lens 146, and finally received by the infrared sensor 148. The infrared sensor 148 can sense a location of the edge of the reflection surface 114 according to the amount of the received infrared rays.

When the touch panel 11 shifts, the infrared sensor 148 can sense a displacement of the edge of the touch panel 11 according to a difference between the amount of the received infrared rays before and after the touch panel 11 is shifted. In other words, the infrared sensor 148 can sense the deformation of the first elastic member 13a. In other embodiments, the displacement sensor 14a can instead be a strain gauge displacement sensor, an inductive displacement sensor, an eddy current displacement sensor, a differential transformer displacement sensor, or a hall displacement sensor.

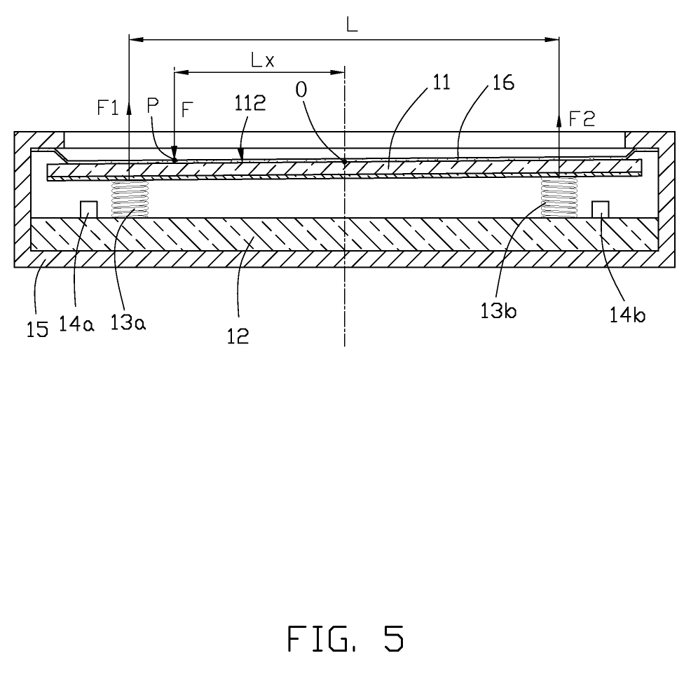

Referring also to FIG. 5, the central point of the touch panel 11 is defined as origin of coordinates O, when a touch point P of the touch surface 112 is touched by the user with a force F. Since the first elastic members 13c, 13d are far away from the touch point P, when in equilibrium, the forces of the first elastic members 13c, 13d can be ignored. Thus, the following equation can be obtained:

F=F₁+F₂ (1),

wherein F₁=kx₁, F₂=kx₂, k is the elasticity coefficient of the first elastic member 13a, x₁, x₂ are deformation of the respective first elastic members 13a, 13b. Since a moment by the force F about the touch point P is zero, the moments by the forces F₁, F₂ about the touch point P must be the total moment about the touch point P, and, when in equilibrium, this is zero. Thus, the following equation can be obtained:

$${F}_{1} ( \frac{L}{2} - {L}_{x} ) = {F}_{2} ( \frac{L}{2} + {L}_{x} ) , \qquad ( 2 )$$

wherein L is the distance from the first elastic members 13a to the first elastic members 13b, Lₓ is the vertical distance from the touch point P to the origin of coordinates O (see FIG. 1).

According to the above equations (1) and (2), the following equation can be obtained:

$${L}_{x} = \frac{Lk ( {x}_{1} - {x}_{2} )}{2 F} .$$

Therefore, the touch panel could be constructed with a relatively large display panel 11 and first elastic members 13a, 13b, 13c, 13d with relatively large elasticity coefficient. In this case, L is close to the width of the touch panel 11. When the force F is applied on the touch panel 11, the force F is far smaller than Lk. Therefore, a change of the force F may be ignored relative to Lk. In other words, the force F can be considered to be a constant, and can be known by testing during design of the touch panel 11. For example, a plurality of forces Fₑₓₚₑᵣᵢₘₑₙₜ can be tested by performing a plurality of touches on different positions of the touch panel 11; then, an average value of the forces is found and taken as F. Similarly, a coordinate L_{y} (see FIG. 1) can be known by the same way of obtaining Lₓ.

The CPU 20 is electrically coupled to the displacement sensors 14a, 14b, 14c, 14d. The CPU 20 is configured for receiving deformation data x₁, x₂, and so on, from the displacement sensors 14a, 14b, 14c, 14d, calculating the coordinates Lₓ and L_{y} of the touch point P according to the data, and determining the touch point P of the touch surface 112 based on the Lₓ and L_{y}.

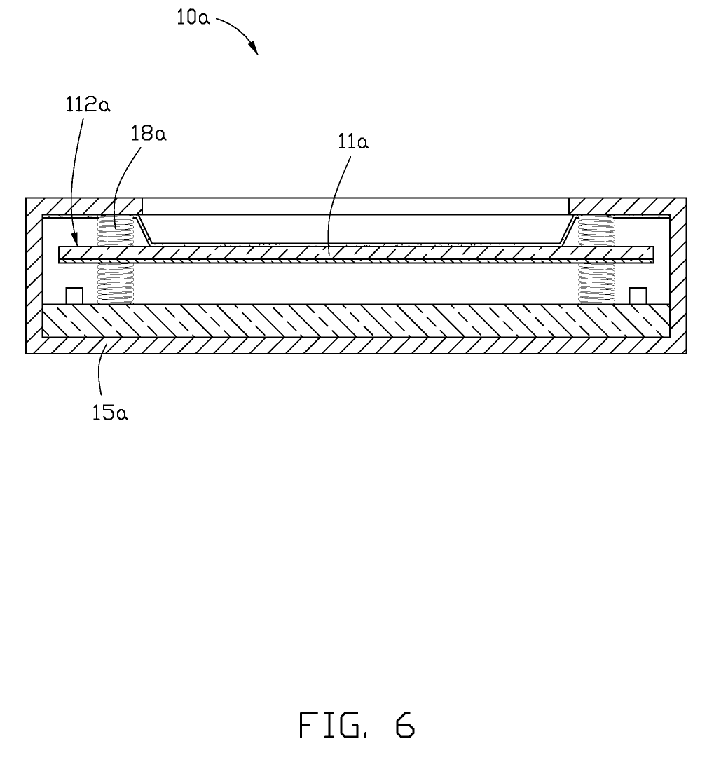

Referring to FIG. 6, a touch panel module 10a, in accordance with a second embodiment, includes a touch panel 11a having a touch surface 112a, and a frame body 15a. Most of the structure of the touch panel module 10a is similar to that of the touch panel module 10, expect that, the touch panel module 10a also includes a plurality of second spring connecting members 18a. The two ends of each second spring connecting member 18a are respectively mounted on the touch surface 112a of the touch panel 11a and the inner wall of the frame body 15a.

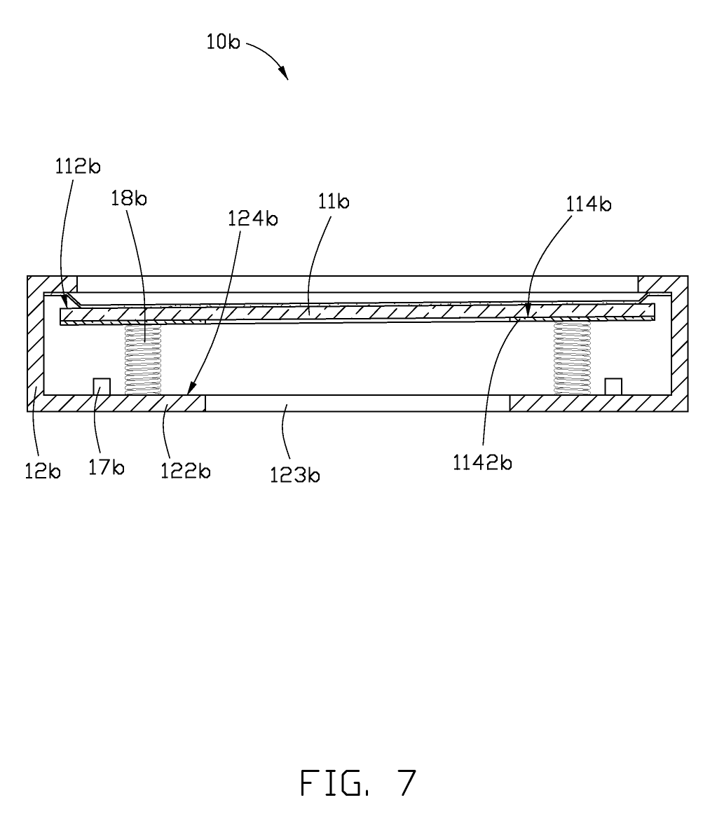

Referring to FIG. 7, a touch panel module 10b, in accordance with a third embodiment, includes a touch panel 11b, a supporting body 12b, four first elastic members 18b, and four displacement sensor 17b. The touch panel 11b includes a touch surface 112b, and a reflection surface 114b opposite to the touch surface 112b. The supporting body 12b is a frame body, and includes a bottom plate 122b defining an opening 123b at the central thereof. The bottom plate 122b includes a ring-shaped supporting surface 124b facing to the reflection surface 114b. The displacement sensors 17b are respectively mounted in four corners on the supporting surface 124b. Four infrared reflection films 1142b are respectively disposed in four corners of the reflection surface 114b, respectively responding to the four displacement sensors 17b. In other embodiment, the bottom plate 122b can instead be a light pervious plate without an opening.

While certain embodiments have been described and exemplified above, various other embodiments will be apparent to those skilled in the art from the foregoing disclosure. The disclosure is not limited to the particular embodiments described and exemplified but is capable of considerable variation and modification without departure from the scope of the appended claims.

What is claimed is:

1. A touch panel module, comprising:
a touch panel, the touch panel comprising a touch surface, and a reflection surface opposite to the touch surface;
a supporting body, the supporting body comprising a supporting surface facing the reflection surface;
a plurality of first elastic members sandwiched between the touch panel and the supporting body, each first elastic member being deformable along a direction substantially perpendicular to the touch surface; and
a plurality of displacement sensors mounted on the supporting surface, each displacement sensor being configured for sensing deformation of the corresponding first elastic member.

2. The touch panel module of claim 1, wherein the displacement sensor comprises an infrared emitter, a collimating lens, a focusing lens, and an infrared sensor, the collimating lens configured for collimating the infrared rays from the infrared emitter, the focusing lens configured for converging the collimated infrared rays, the infrared sensor configured for receiving the converged infrared rays, thus sensing a location of the edge of the reflection surface according to the amount of the received infrared rays.

3. The touch panel module of claim 1, wherein the touch panel is square shaped, the plurality of displacement sensors including four displacement sensors spatially corresponding to the respective corners of the reflection surface for sensing deformation of the first elastic members.

4. The touch panel module of claim 1, further comprising an infrared reflection film formed on the reflection surface.

5. The touch panel module of claim 1, further comprising a frame body, and the frame body is configured for receiving the touch panel and the supporting body therein.

6. The touch panel module of claim 5, wherein the supporting body is a crystal display panel, or a light pervious plate.

7. The touch panel module of claim 1, wherein the supporting body is a frame body, the bottom plate of the supporting body comprises the supporting surface, the touch panel is received in the supporting body.

8. The touch panel module of claim 7, wherein the bottom plate further comprises an opening defined in the center thereof.

9. The touch panel module of claim 1, further comprising a protecting film adhered on the touch surface of the touch panel.

10. A touch panel system, comprising:
a touch panel, the touch panel comprising a touch surface, and a reflection surface opposite to the touch surface;
a supporting body, the supporting body comprising a supporting surface facing to the reflection surface;
a plurality of first elastic members sandwiched between the touch panel and the supporting body, each first elastic member being deformable along a direction substantially perpendicular to the touch surface; and
a plurality of displacement sensors mounted on the supporting surface, each displacement sensor being for sensing deformation of the corresponding first elastic member; and
a central processing unit, the central processing unit configured for determining a touch point on the touch surface based on the deformation of the first elastic members sensed by the displacement sensors.

11. The touch panel system of claim 10, wherein the displacement sensor comprises an infrared emitter, a collimating lens, a focusing lens, and an infrared sensor, the collimating lens configured for collimating the infrared rays from the infrared emitter, the focusing lens configured for converging the collimated infrared rays, the infrared sensor configured for receiving the converged infrared rays, thus sensing a location of the edge of the reflection surface according to the amount of the received infrared rays.

12. The touch panel system of claim 10, wherein the touch panel is square shaped, the plurality of displacement sensors including four displacement sensors spatially corresponding to the respective corners of the reflection surface for sensing deformation of the first elastic members.

13. The touch panel system of claim 10, further comprising an infrared reflection film formed on the reflection surface.

14. The touch panel system of claim 10, further comprising a frame body, and the frame body is configured for receiving the touch panel and the supporting body therein.

15. The touch panel system of claim 14, wherein the supporting body is a crystal display panel, or a light pervious plate.

16. The touch panel system of claim 10, wherein the supporting body is a frame body, the bottom plate of the supporting body comprises the supporting surface, the touch panel is received in the supporting body.

17. The touch panel system of claim 16, wherein the bottom plate further comprises an opening defined in the center thereof.

18. The touch panel system of claim 10, further comprising a protecting film adhered on the touch surface of the touch panel.
